(19) United States
(12) Patent Application Publication
(10) Pub. No.: US 2008/0184583 A1
(43) Pub. Date: Aug. 7, 2008

(54) MICROMETER-BASED MEASURING SYSTEM AND METHOD OF USING SAME

(75) Inventors: LEI LI, Shenzhen (CN); PING CHEN, Shenzhen (CN); YUN-FANG ZHAO, Shenzhen (CN); DONG LI, Shenzhen (CN); ZHI-LI CHEN, Shenzhen (CN); JUN JIANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRIAL CO.,LTD., Shenzhen (CN); SUTECH TRADING LIMITED, Tortola (VG)

(21) Appl. No.: 11/767,022

(22) Filed: Jun. 22, 2007

(30) Foreign Application Priority Data
Feb. 2, 2007 (CN) 200710073074.8

(51) Int. Cl. G01B 3/18; G01B 5/02

(52) U.S. Cl. 33/819

(57) ABSTRACT

A measuring system (100) includes a measuring instrument (10) and a processing device (20). The measuring instrument includes a base (12), a guide column (14), a sliding member (16), and a digital micrometer (18). The guide column is vertically attached to the base. The sliding member is moveably attached to the guide column. The digital micrometer is firmly fastened to the sliding member. The processing device is electronically connected with the digital micrometer. The processing device receives a measured value from the digital micrometer and diplays a testing result after processing the measured value.

### BACKGROUND OF THE INVENTION

1. Field of the Invention

The present invention relates to measuring systems and, particularly, to a measuring system with a digital micrometer.

2. Description of Related Art

In industrial production, it is often necessary to test the dimension of workpieces so as to ensure the quality of the products. Manufacturers generally use a single micrometer or a three-dimensional measuring apparatus to measure the workpieces.

Although micrometers are light and handy, when a surveyor/inspector uses a single micrometer to measure the workpieces, the surveyor usually needs to read and note the parameters by hand. Accordingly, it might take much time to complete this process. What is more, it can be easy to make mistakes when reading such measurements. In addition, the surveyor needs to determine whether the dimension of the workpiece is acceptable or not. As such, not only is the work burden of the surveyor increased, but also the time needed to finish measuring is increased.

The three-dimensional measuring apparatus is generally large and complex, so that it tends to be hard to move. Therefore, the three-dimensional testing apparatus is suitable for placement in a laboratory to measure small quantities of samples, but it is not generally suitable for measuring products in large-scale production.

Therefore, a new measuring system is desired in order to overcome the above-described problems.

### SUMMARY OF THE INVENTION

In one embodiment thereof, a measuring system includes a measuring instrument and a processing device. The measuring instrument includes a base, a guide column, a sliding member, and a digital micrometer. The guide column is vertically attached to the base. The sliding member is moveably attached to the guide column. The digital micrometer is firmly fastened to the sliding member. The processing device is electronically connected with the digital micrometer. The processing device receives a measured value from the digital micrometer and shows/displays test results after processing the measured value.

Other advantages and novel features will become more apparent from the following detailed description when taken in conjunction with the accompanying drawings.

### BRIEF DESCRIPTION OF THE DRAWINGS

Many aspects of the measuring system can be better understood with reference to the following drawings. The components in the drawings are not necessarily drawn to scale, the emphasis instead being placed upon clearly illustrating the principles of the present measuring system. Moreover, in the drawings, like reference numerals designate corresponding parts throughout the several views.

FIG. 1 is an assembled, isometric view of a measuring system, in accordance with a present embodiment;

FIG. 2 is an exploded, isometric view of the measuring instrument shown in FIG. 1; and

FIG. 3 is a schematic view of a processing device shown in FIG. 1.

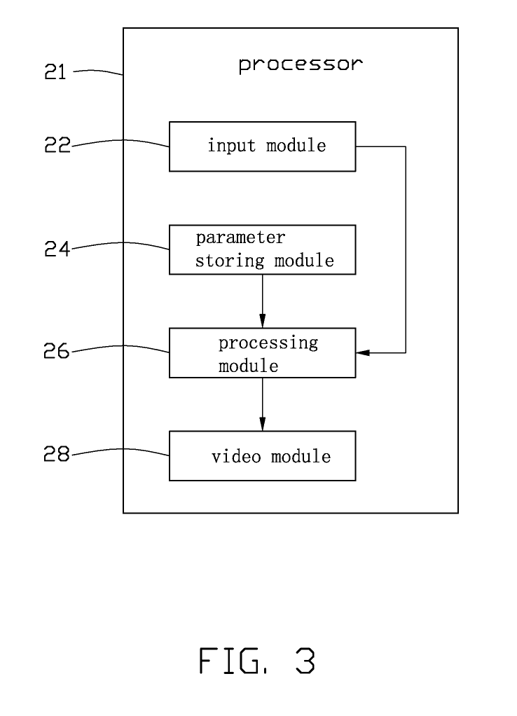

### DETAILED DESCRIPTION OF THE INVENTION

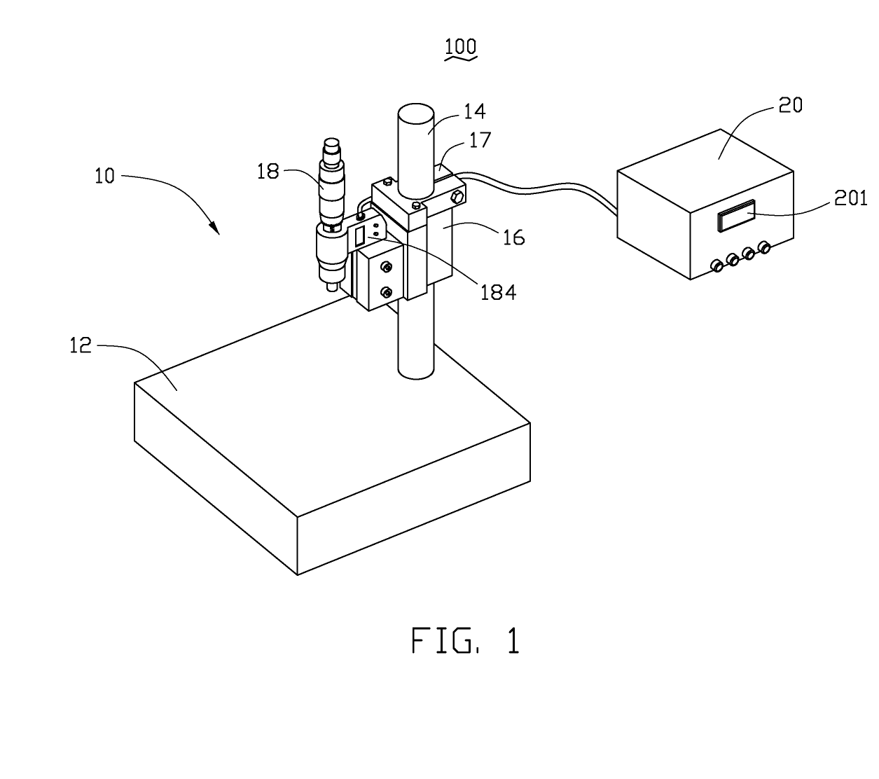

Referring now to FIG. 1, the measuring system 100 includes a measuring instrument 10 and a processing device 20 connected/linked with the measuring instrument 10, in accordance with a present embodiment.

The measuring instrument 10 includes a base 12, a guide column 14, a sliding member 16, a fastening member 17, and a digital micrometer 18.

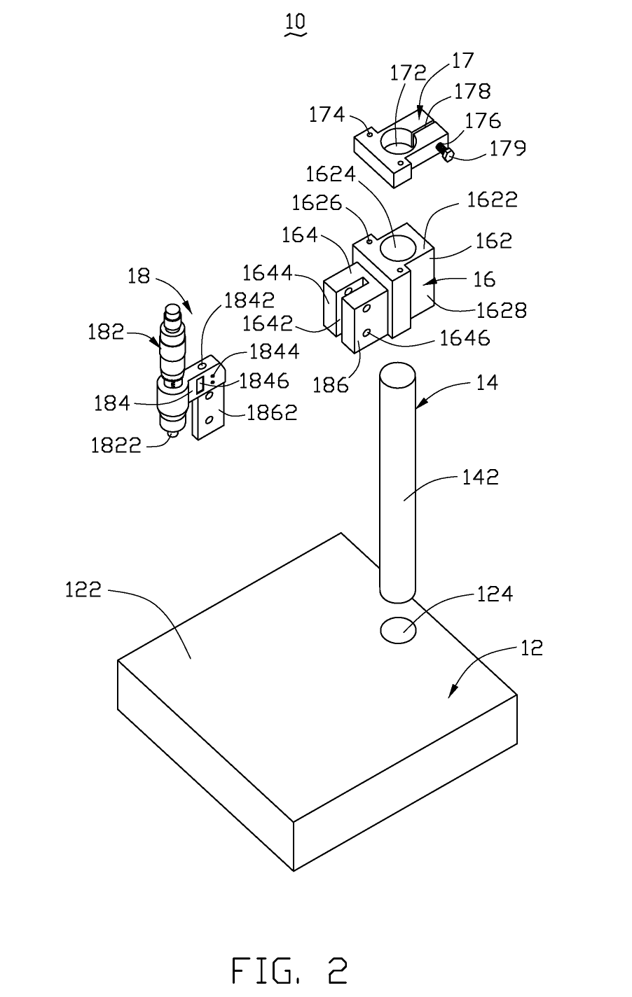

Referring to FIG. 2, the base 12 is a rectangular flat board. The base 12 has an essentially flat upper surface 122, so that a workpiece might be flatly laid on it, so as to reduce errors in measuring. The base 12 may, advantageously, be made of a metal with high density, such as stainless steel or the like, so that the weight and linear dimensions of the base 12 together are enough to keep balance of the measuring instrument 10 (i.e., base 12 beneficially acts as a ballast for the measuring instrument 10). A fixing hole 124 is defined adjacent to an edge portion of the base 12.

The guide column 14 may, advantageously, be made of a durable, rigid material, such as stainless steel, copper alloy, or the like, so that the guide column 14 might keep its shape even after repeated use. The guide column 14 has a smooth circumference surface 142 and thus is configured (i.e., structured and arranged) for allowing the sliding member 16 to be easily moved along the guide column 14. The guide column 14 is configured for engaging in the fixing hole 124 of the base 12.

The sliding member 16 includes a main block 162 and a rectangular extending block 164. The main block 162 is an approximately cuboid (e.g., cube-shaped or rectangular parallelepiped) body and has a top surface 1622. A guide hole 1624 is defined in a central area of the top surface 1622. Two threaded holes 1626 are defined at opposing ends of the main block 162 and respectively positioned beside the guide hole 1624. Two opposite sidewalls 1628 of the main block 162 are recessed so as to reduce the weight of the sliding member 16. The extending block 164 extends directly (e.g., via co-molding or direct attachment) from a surface of the main block 162. A latching notch 1642 is defined in a middle/central area of the extending block 164. The latching notch 1642 has a rectangular cross-section. The latching notch 1642 extends through the extending block 164, and, thus, two wings 1644 are formed opposite to each other. Each wing 1644 has two through threaded holes 1646 defined therein. The position and the shape of the threaded holes 1646 in one wing 1644 respectively correspond to those of the threaded holes 1646 in the other wing 1644.

The shape of the fastening member 17 is the same as that of the main block 162 of the sliding member 16. A through hole 172 is defined in a central area of the fastening member 17. The through hole 172 has an approximately similar diameter to the guide column 14, facilitating a slide fit therebetween. Two through threaded holes 174 are defined in an edge of the fastening member 17. The two through threaded holes 174 respectively correspond to the threaded holes 1626 of the main block 162. A bore 176 is defined in a sidewall of the fastening member 17 and is perpendicular to an axis of the through hole 172. A slot/aperture 178 is defined across the fastening member 17 and enables the through hole 172 to communicate with the surrounding environment. The width of the slot/aperture 178 is large enough that the fastening member 17 is moveable relative to the slot/aperture 178. The bore 176 communicates with the aperture 178. An adjusting screw 179 is rotated into the bore 176 and fastens the two opposite side portions of the slot/aperture 178. Therefore, the diameter of the through hole 172 might be enlarged or reduced by rotating the adjusting screw 179.

The digital micrometer 18 includes a main body 182, a dial plate 184, and a fixing portion 186. The main body 182 includes a testing column 1822 and a gear 1824. The user may selectably rotate the gear 1824 so as to lift the testing column 1822 up or down by a desired amount. The dial plate 184 is positioned beside the main body 182 and is configured for showing/indicating test results of the digital micrometer 18. An output interface 1842 is formed in a sidewall of the dial plate 184. The output interface 1842 is configured for transmitting dimensions to the processor 21. A zero reset button 1844 is located beside the dial plate 184, so that the dial plate 184 might directly show a movement distance of the testing column 1822. That is, the zero reset button 1844 is configured for selectably establishing a zero reference level or datum plane, to provide a basis for measurement. The fixing portion 186 extends directly from another sidewall of the dial plate 184. The fixing portion 186 is configured for being received in the latching notch 1642. Two round holes 1862 are defined in the fixing portion 186. The two round holes 1862 respectively correspond to the threaded holes 1646 of each wing 1644, so that the digital micrometer 18 may be fastened to the sliding member 16, e.g., by means of screws.

In assembly of the measuring instrument 10, firstly, the fixing portion 186 of the digital micrometer 18 is inserted into the latching notch 1642. Two first screws then fasten the digital micrometer 18 to the sliding member 16 via the screw holes 1646 of the extending block 164 and the round holes 1862 of the fixing portion 186. Secondly, the fastening member 17 is placed on the sliding member 16, with the threaded holes 174 of the fastening member 17 respectively corresponding to those of the sliding member 16. Two second screws are threaded into corresponding threaded holes 174 of the fastening member 17 and the sliding member 16, respectively, so that the fastening member 17 is firmly attached to the sliding member 16. After that, the guide column 14 is inserted into the guide hole 1624 of the sliding member 16 and the through hole 172 of the fastening member 17. The adjusting screw 179 is rotated inside so as to reduce the diameter of the through hole 172. Accordingly, an inner surface of the fastening member 17 tightly contacts with the circumference surface 142 of the guide column 14, effectively selectably creating a tolerance fit therebetween. Therefore, the fastening member 17 with the sliding member 16 and digital micrometer 18 is firmly fastened to the guide column 14 by means of a frictional force produced between the inner surface of the fastening member 17 and the circumference surface 142 of the guide column 14. The guide column 14 is inserted into the fixing hole 124 of the base 12, with the digital micrometer 18 facing the center of the base 12. At last, when the guide column 14 and the digital micrometer 18 are secured perpendicular to the base 12, the guide column 14 is firmly fastened, e.g., by a solder, an adhesive, or other means.

The processing device 20, which advantageously is a computer or a programmable logic controller (PLC), is used to process the data from the measuring instrument 10 and show/display a result. The processing device 20 includes, at least, a processor 21 and a display 201. The processor 21 has an input module 22, a parameter-storing module 24, a processing module 26, and a video-conversion module 28. The input module 22 connects with the output interface 1842 of the digital micrometer 18 and can receive data (e.g., measured values) from the digital micrometer 18 via an electronic connection such as a data wire or a wireless link. The parameter storing module 24 stores reference data, which is, e.g., input by a user or transmitted from a data bank. The reference data is, for example, a series of numbers in a certain range. The processing module 26 is configured for receiving the data transmitted from the input module 22 and for then processing and comparing it with the reference data, so as to give/yield a result. The video-conversion module 28 is used to receive the signal of the result and transform it into a video signal. The video-conversion module 28 electronically connects (e.g., hard-wire or wireless link) with the display 201, so that the result might be shown via the display 201. It is to be further understood that the processing module 26 could be linked to a printer (not shown), as well, or, potentially, alternatively. Either way, the display 201 and/or the printer would serve as data output modules.

In use, firstly, the user places a reference-standard block (not shown) (i.e., a calibration element) on the upper surface 122 of the base 12, with the reference-standard block under the testing column 1822 of the digital micrometer 18. In particular, the reference-standard block in this instance is a block that does not have a workpiece mounted/carried thereon (opposed to such a similarly constructed block with a workpiece thereon). The gear 1824 is then rotated, and the testing column 1822 moves down. When the testing column 1822 touches the reference-standard block, the zero reset button 1844 is pressed down, and the dial plate 184 shows “0”. The plane where the end surface of the testing column 1822 is positioned is a datum plane. The height of the end surface of the testing column 1822 is thus zeroed.

Secondly, the user inputs a reference data of a height of a normal workpiece and the height of the reference-standard block into the processing device 20. The reference data is stored in the parameter-storing module 24.

Thirdly, a workpiece is placed on the base 12, under the testing column 1822. The gear 1824 is rotated so that the testing column 1822 moves down and touches the workpiece. The dial plate 184 shows/indicates the movement distance of the testing column 1822. When the workpiece is lower/shorter than the reference-standard block, the number/value is positive. Otherwise, when the workpiece is higher/taller than the reference-standard block, the number is negative. The signal corresponding to the number/value is transmitted to the input module 22 of the processor 21 via the data link. The processing module 26 receives the signal corresponding to the number from the input module 22. The height of the reference-standard block stored in the parameter-storing module 24 is subtracted from the number, and the result is the height of the workpiece. If the result is in the reference range of the workpiece height, the display 201 will show “pass”, indicating that the workpiece is suitably dimensioned. Otherwise, if the result is out of the reference range, the display 201 will show “reject”, which means the workpiece has one or more dimensions that are not in the acceptable range.

It should be understood that if the reference data is not changed, the process of inputting reference range of the workpiece height and the height of the reference-standard block may be omitted during the next testing.

In an alternative embodiment of the present invention, the fixing portion 186 is soldered or welded to the sliding member 16. Further, the dial plate 184 could take the form of a mechanical (e.g., movable dial/gage) or a digital/electronic display and be within the scope of the present measuring system 100.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A measuring system, comprising:
a linear measuring instrument including a base, a guide column, a sliding member, and a digital micrometer, the guide column being vertically attached to the base, the sliding member being moveably attached to the guide column, the digital micrometer being firmly fastened to the sliding member; and
a processing device electronically connecting with the digital micrometer;
wherein the processing device receives a measured value from the digital micrometer and displays a testing result after processing the measured value.

2. The measuring system as claimed in claim 1, wherein the digital micrometer comprises a testing column and a gear, and the testing column is moveable along an axis thereof via selectable rotation of the gear.

3. The measuring system as claimed in claim 2, wherein the digital micrometer further comprises a dial plate configured for indicating the measured value and an output interface configured for transmitting the measured value to the processing device.

4. The measuring system as claimed in claim 3, wherein the digital micrometer further includes a zero reset button.

5. The measuring system as claimed in claim 1, wherein a guide hole is defined in the sliding member, and the guide column is engaged with the guide hole.

6. The measuring system as claimed in claim 5, further comprising a fastening member, wherein the fastening member is firmly attached to the sliding member, and the fastening member is flexibly attached to the guide column.

7. The measuring system as claimed in claim 6, wherein the fastening member has a through hole and a slot defined therein, and the aperture extends across the fastening member and permits the through hole to communicate with the ambient.

8. The measuring system as claimed in claim 7, wherein a bore is defined in the fastening member, the bore is divided into two parts by the aperture, and an adjusting screw is engaged with the bore to facilitate adjustment of the diameter of the through hole.

9. The measuring system as claimed in claim 5, wherein the sliding member includes a main block and an extending block, the extending block extends from a side surface of the sliding block, and the guide hole is defined in the extending block.

10. The measuring system as claimed in claim 9, wherein the digital micrometer further comprises a fixing portion, the extending block of the sliding member has a latching notch, the fixing portion is received in the latching notch, and the fixing portion is firmly attached to the sliding member by means of screws.

11. The measuring system as claimed in claim 3, wherein the processing device comprises a processor and a display, the processor electronically connects with the output interface of the digital micrometer, and the display electronically connects with the processor.

12. The measuring system as claimed in claim 11, wherein the processor includes a parameter-storing module, and the parameter-storing module stores reference data.

13. A method for measuring, comprising the steps of:
providing a linear measuring system, the measuring system including a measuring instrument and a processing device;
inputting reference data into the processing device;
measuring a workpiece using the measuring instrument so as to gain a testing dimension; and
using the processing device to determine a relation between the testing dimension and the reference data so as to yield a testing result.

14. The method as claimed in claim 13, wherein a reference-standard block cooperates with a digital micrometer of the measuring instrument so as to establish a zero reference level.

15. The measuring system as claimed in claim 13, wherein the processing device subtracts the testing dimension from the height of the reference-standard block and compares the result with the reference data so as to yield a testing result.

16. A measuring system, comprising: a linear measuring instrument including a base, a guide column, and a measuring assembly, the measuring assembly attached to the guide column, the measuring assembly including a digital micrometer moveably positioned above the base; and
a processing device electronically connected with the digital micrometer;
wherein the processing device receives a measured value from the digital micrometer and displays a testing result after processing the measured value.

17. The measuring system as claimed in claim 15, wherein the measuring assembly comprises a fastening member, and the fastening member is flexibly attached to the guide column.

18. The measuring system as claimed in claim 17, wherein the fastening member has a through hole and a slot defined therein, and the aperture extends across the fastening member and permits the through hole to communicate with the ambient.

19. The measuring system as claimed in claim 18, wherein a bore is defined in the fastening member, the bore is divided into two parts by the aperture, and an adjusting screw is engaged with the bore for selectably adjusting the diameter of the through hole.
